(19) United States
(12) Patent Application Publication
(10) Pub. No.: US 2008/0177608 A1
(43) Pub. Date: Jul. 24, 2008

(54) BUSINESS METHOD FOR ENABLING PERSONALIZED MEDICINE

(75) Inventor: Peter Keeling, Belfast (GB)

Correspondence Address: FOLEY AND LARDNER LLP;SUITE 500, 3000 K STREET NW, WASHINGTON, DC, 20007, US

(73) Assignee: Diaceutics

(21) Appl. No.: 11/625,242

(22) Filed: Jan. 19, 2007

(51) Int. Cl. G06F 9/50

(52) U.S. Cl. 705/8

(57) ABSTRACT

A method of determining a theranostic plan for a pharmaceutical, the plan being optimized in terms of return on investment (ROI), the method comprising, determining a plurality of planning frameworks which take the pharmaceutical from a point of conception to a point of marketing and beyond, for the or each framework determining a plurality of planning steps which lead to the definition of a plurality of required decisions, effecting a plurality of decisions corresponding to the required decisions, carrying out the plurality of decisions in a predetermined order, based on the framework and planning steps, so as to put the theranostic plan into effect, wherein the carrying out the decisions is made so as to optimize the ROI of the theranostic plan.

### FIELD OF THE INVENTION

The present invention relates to a business method for facilitating the provision of personalized medical services. In particular the invention relates to an improved business method for enabling such services.

### BACKGROUND OF THE INVENTION

The pharmaceutical and diagnostic industries have occupied the same market place for many years. However, the two industries have evolved in very different ways using two very different models. These different business models are culturally and financially distinct. When the two are required to work together the result is often suboptimal in terms of clinical and business solutions.

In the past, a patient was diagnosed and then treated in separate parts of the same system. The distinct identities of diagnosis and therapeutics have coexisted to provide an overall continuum of care to the patient. There has been occasional collaboration between diagnostic and therapeutic systems but generally the two have operated without collaboration.

The present emphasis is now on personalized medicine in key therapeutics areas. In particular these relate to therapy targeted by novel molecular diagnosis. As a result it will become and is becoming critical to integrate the pharmaceutical and diagnostic business model in order that the two can cooperate.

The advent of personalized medicine requires parallel development of a diagnostic; and diagnostic market or franchise to enable doctors to choose and monitor specific therapies. The efficiency of this interdependency will in turn rely on the ability of each industry to understand the drivers of the other. This would then enable the industries to find new ways to partner profitably around the same clinical proposition.

As consequence of this there is an on going search for the correct business model which would allow the pharmaceutical and diagnostic industries to collaborate with each other in a profitable manner. A particular challenge is the huge variation of market and product circumstances which make finding a single business model complex and unlikely to happen in the near future.

### ASPECTS OF THE PRESENT INVENTION

One object of the present invention is to provide a means of developing a business model which will maximize the return on investment for the pharmaceutical and diagnostic industries when working together in the environment of personalized medicine.

According to one aspect of the present invention there is provided a method of determining a theranostic plan for a pharmaceutical, the plan being optimized in terms of return on investment (ROI), the method comprising: determining a plurality of planning frameworks which take the pharmaceutical from a point of conception to a point of marketing and beyond; for the or each framework determining a plurality of planning steps which lead to the definition of a plurality of required decisions; effecting a plurality of decisions corresponding to the required decisions; carrying out the plurality of decisions in a predetermined order, based on the framework and planning steps, so as to put the theranostic plan into effect, wherein the carrying out the decisions is made so as to optimize the ROI of the theranostic plan.

Preferably the step of determining a plurality of planning frameworks comprises determining one or more of the following frameworks: a strategic framework; a clinical framework; a regulatory framework; an access framework; a marketing framework; a selling framework; a lifecycle framework; and a partner framework.

Preferably the method includes determining a plurality of planning steps which lead to the definition of a plurality of required decisions comprising determining one or more of the following steps: identifying one or more myths associated with a framework; identifying one or more realities associated with a framework; identifying one or more objectives associated with a framework; identifying one or more required decisions associated with a framework.

Preferably the method further comprises carrying out the decisions by determining the answers to one or more key questions for the or each framework.

Preferably the method further comprises translating the theranostic plan into a partner selection tool.

Preferably the method further comprises assessing the perception of the complexity of a new test by measuring one of more of the following attributes associated with the test: reimbursement levels; turnaround time for the test; interpretations of results; patient engagement; and test administration.

According to another aspect of the present invention there is provided a system for determining a theranostic plan for a pharmaceutical, the plan being optimized in terms of return on investment (ROI), the system comprising: a plurality of planning frameworks which take the pharmaceutical from a point of conception to a point of marketing and beyond; for the or each framework a plurality of planning steps which lead to the definition of a plurality of decisions; wherein the plurality of decisions are carried out in a predetermined order, based on the framework and planning steps, so as to put the theranostic plan into effect, and wherein the carrying out the decisions is made so as to optimize the ROI of the theranostic plan.

According to a further aspect of the present invention there is provide a computer program comprising instructions for carrying out the steps of determining a theranostic plan for a pharmaceutical, the plan being optimized in terms of return on investment (ROI), comprising: determining a plurality of planning frameworks which take the pharmaceutical from a point of conception to a point of marketing and beyond; for the or each framework determining a plurality of planning steps which lead to the definition of a plurality of required decisions;

effecting a plurality of decisions corresponding to the required decisions;

carrying out the plurality of decisions in a predetermined order, based on the framework and planning steps, so as to put the theranostic plan into effect, wherein the carrying out the decisions is made so as to optimize the ROI of the theranostic plan, the steps being effected when said computer program is executed on a computer system.

An advantage of the invention is that this defines and tailors the optimum research and development business models to enable the maximum return on a given therapy or treatment.

The invention provides a mean of addressing a number of objective key actions and decisions as required to comprehensively assess the specific theranostic planning needs required to maximize this return on the therapy. The invention further goes on to assist with the understanding of the context within which the decisions and objectives need to be taken. A consensus is created in respect of the most appropriate theranostic technology required to maximize the return on investment for that therapy. The invention also assists in a completion of a strategic and tactical plan in support of the specific business model chosen and in a selection of the appropriate theranostic partnerships to maximize the return on the investment for the therapy.

### REFERENCES TO THE FIGURES

FIG. 1 is a diagram identifying planning frameworks in accordance with an embodiment of the present invention.

FIG. 2 is a diagram identifying planning steps in accordance with an embodiment of the present invention.

FIG. 3 is a diagram identifying a theranostic plan in accordance with an embodiment of the present invention.

FIG. 4 is a diagram of all the steps in accordance with an embodiment of the present invention.

FIG. 5 is a diagram identifying getting the details right in accordance with an embodiment of the present invention.

### DETAILED DESCRIPTION OF THE PRESENT INVENTION

The basic business method is made up of three main steps:
a research step;
a consensus workshop; and
a plan capture stage.

The research step enables an understanding of the return on investment (ROI) needs of the therapy through market research and internal interviews via a novel template which will influence the relevant theranostic business model. In addition an understanding the potential diagnostic technology options which might address those needs in a timely way is enabled.

The consensus workshop comprises a number of elements including:
As a result of the research step, case studies are selected which match the context into which the pharmaceutics company is likely to commercialize a theranostic;
The case studies are further presented via 8 frameworks which themselves reflect the commercialization cycle and steps necessary to bring a new theranostic to market. This will be described in greater detail below;
The pharmaceutics team considers each framework in sequence. The order of the sequence is important;
The case studies are presented using:
   A myth and reality approach to take pharmaceutics teams from a position of ignorance to a position of awareness about the relevant theranostic market (a total of x myths and reality discussions are employed).
   Each frame work myth and reality is then summarized using a predictable entry equation which defines the key objectives (e.g. 1 per framework); and
   A number of key strategic actions required for that framework are identified.
A series of work tools (e.g. 13) are then employed to help pharmaceutics teams tailor or contextualize a number of these key strategic actions to their product.
A decision capture is then employed to capture the decisions arising from the key strategic actions (e.g. 30 decisions).
This is then repeated by framework eventually building up a total picture of all the strategic elements and tactical decisions which will deliver the necessary ROI for the therapy.
Collectively the strategic elements (generic to each therapy) and specific decisions (specific to each therapy) serve to create a unique business model for those therapies theranostic needs.

The plan capture stages then follows and the output of the consensus workshop is augmented with data from a predictive model to create at theranostic plan which is the final written capture document for all decisions and modeling. The theranostic plan also contains a specific appendix which translates the pharmaceutics company's theranostic plan into a partner selection tool.

The table 1 below shows how for each framework the flow may progress to arrive at the relevant and appropriate decisions.

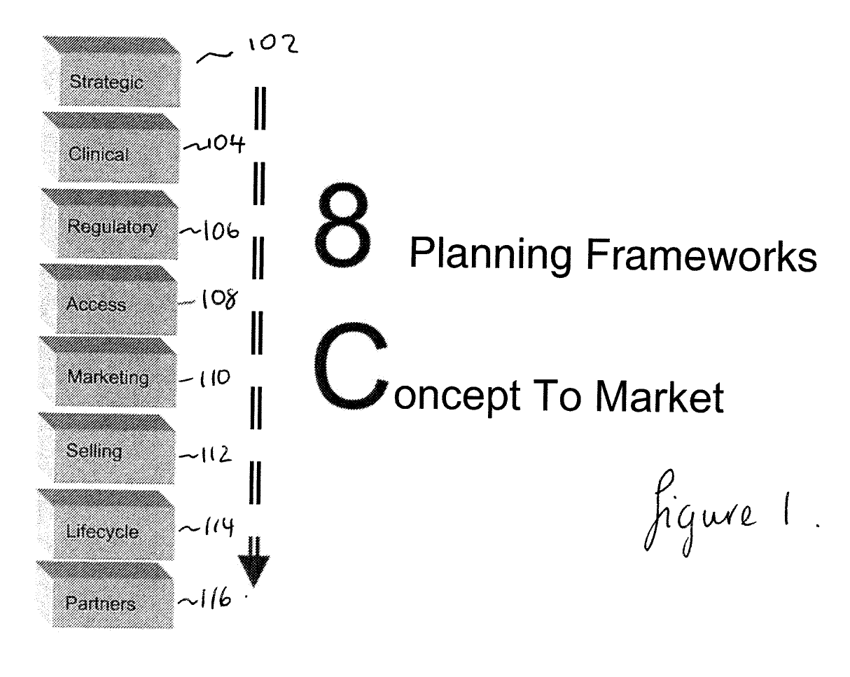

Referring to FIG. 1, an eight stage planning frameworks is displayed this is an example of how a concept can be moved from ideas through to market place for a personalized medicine. The frameworks include strategic, clinical, regulatory, access, marketing, selling, lifecycle and partners. These are numbered respectively 102, 104, 106, 108, 110, 112, 114, and 116. These are the same frameworks as are identified in the table above.

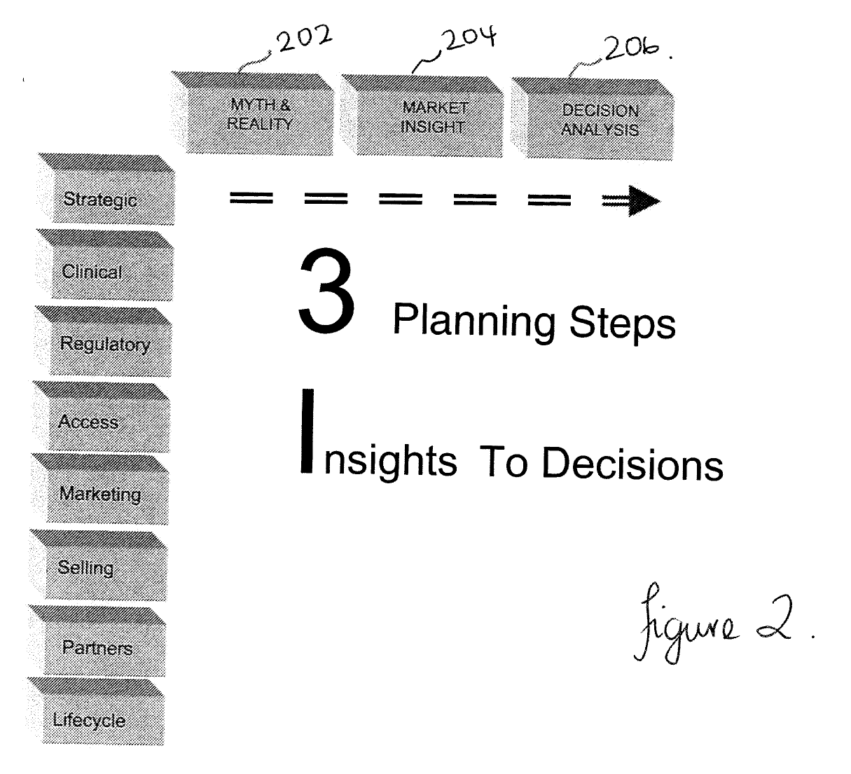

Referring now to FIG. 2, for each planning framework there are three distinct planning steps, which bring about the objective of the table above. These distinct planning steps deal with the myth and reality of each of the planning frameworks; and market insight relating to that framework (which are associated with the predictive entry equations mentioned above) and a decision and analysis module or step to determine the decision to be made. These are respectively 202, 204 and 206.

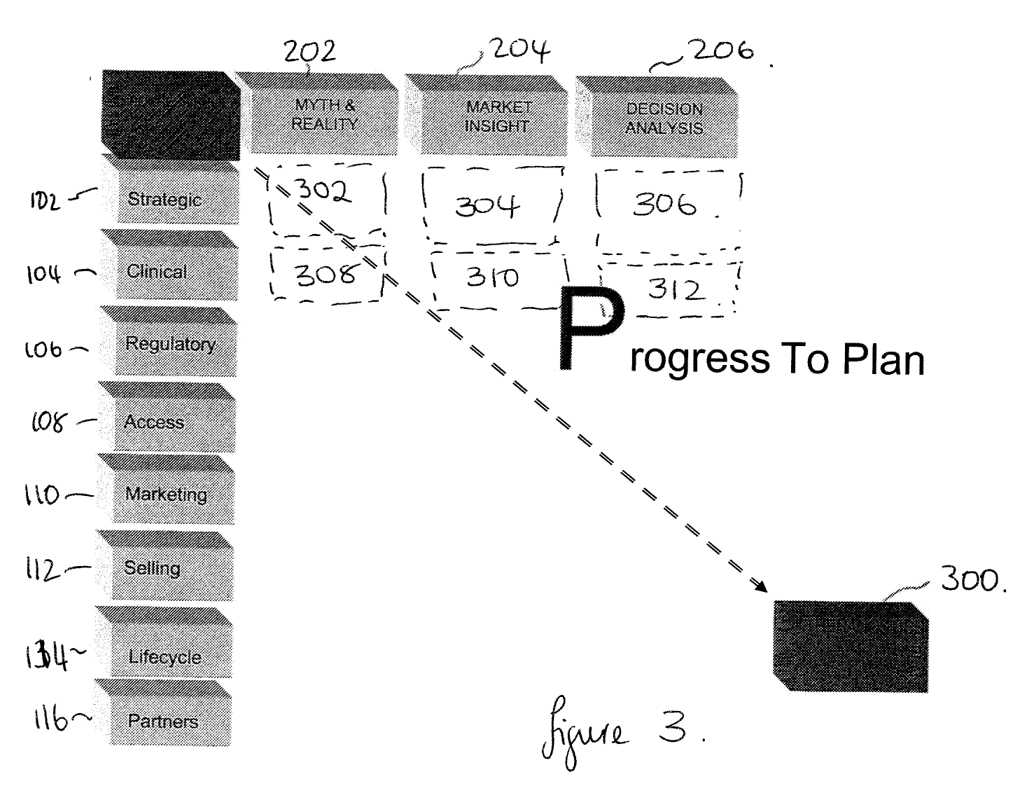

Referring now to FIG. 3, the object of the framework and planning steps is to progress to a theranostic plan 300. This is achieved by taking some or all of the steps for each framework in predetermined order. For example the strategic myth and reality step 302 is carried out first. Then the strategic market insights 304, then the strategic decision analysis 306. After that the clinical myth and reality step 308 is carried out and so on.

It will be appreciated that there may be more than one step carried out at a time and the order of the steps may vary for different plans and progressions to plan. For certain plans or progressions it may be possible to use steps for earlier similar plans or progressions.

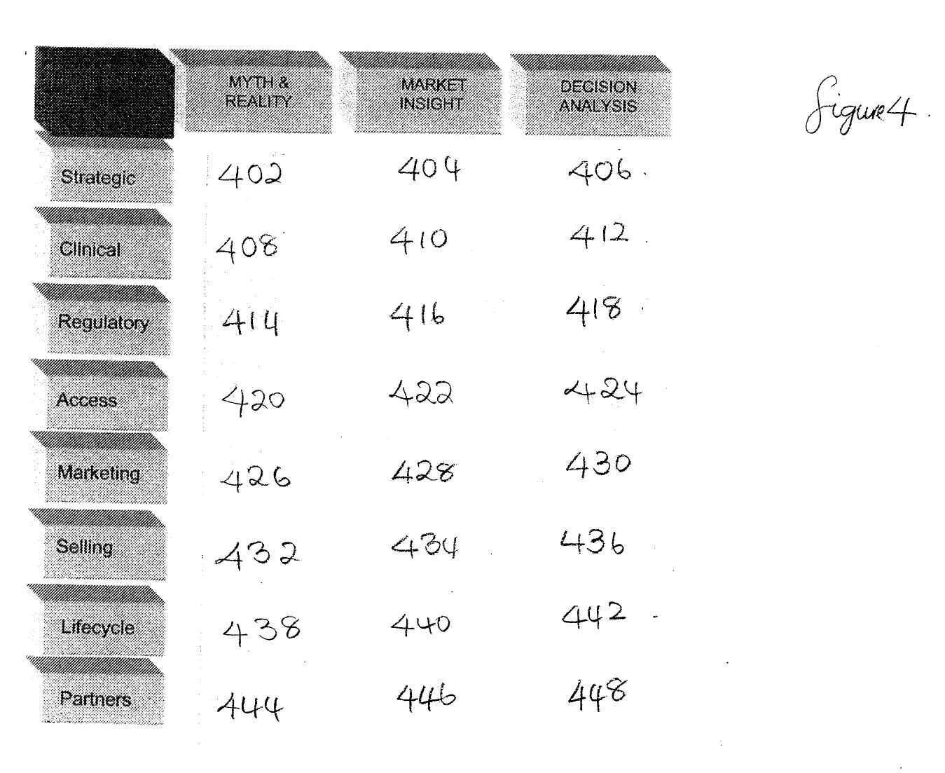

Referring now to FIG. 4 each step 402-448 will now be described in detail.

Step 402 challenges the myth that test adoption is not required until close to launch of the pharmaceutical. In fact, the reality is that early adoption planning of a novel test is substantially equal in importance to the technology. It requires persistence, partnership and sustained budget commitment from day one. The manner in which this may be further explained is by way of examples that have either failed or succeeded by respectively ignoring or following the reality.

Step 404 gives the market insight that predictable entry into a market place is the effect of a number of different elements. In this case: defined adoption goals and correct technology fits will give predictable entry. This predictable entry can be guarantee with smart technology and good clinical results whilst minimizing the expenditure as a result of early consideration of the necessary elements.

Step 406 requires the strategic decision and analysis step in which two decisions will be identified. These two decisions are: defining the adoption goals and considering technology fit. For example, this may involve the opportunity to test index (OTTI). This bears in mind the fact that there are no consistent measures of market share potential in diagnosis; merely a bench mark to estimate diagnostic adoption. For example 5% of doctors using a test 100% of a time or a 100% doctors using a test 5% to the time are not necessarily equivalent. Each of these opportunities need to be assessed to determine the viability of a specific test. This enables decision making to be made in respect to adoption goals and technology fit. By determining the type of technology that matches the timing of the development of the plan the best technology fit can be found. Similarly by determining adoption goals similar considerations may be made therewith.

The Opportunity To Test Index (OTTI) is a technique that is useful to forecast the level of complexity a novel test will be perceived to have when first introduced to a provider at launch. Since the aim of personalized medicine is to ensure that a provider will implement or order the test in a timely way to enable therapeutic choices, the index defines the level of receptiveness a provider will have to that test. The concept of OTTI is simple. On a given day, what opportunity does the provider have to obtain and manage a seamless, trouble-free test answer. If he or she uses the test and obtains a seamless test outcome then the test Index is 1 or perfect. The provider can then proceed to prescribe the targeted therapy. If an impediment to the test answer occurs that impedes easy patient management, then the Opportunity To Test Index is less than 1.

We can break this down further by considering which aspects of a test implementation create complexity in the first place and giving each of them a sub-level score. The following elements influence the provider's perception of the complexity of a new test:
Reimbursement;
Turnaround time for the test;
Interpretations of results;
Patient engagement; and
Test Administration.

Each of these aspects are considered in order to determine a measurement of the index with respect to each of the elements as identified above.

The decisions may also be represented by means of questions. For the strategic framework the questions are:
Which technology options appear to match our test timing/adoption needs best at this stage?
If no current options match—what is our latest acceptable launch to determine if we can fast track an alternative?

Step 408 challenges the myths and realities with respect to the clinical framework. It is a myth that choosing the right biomarker is all that it is important for test adoption. In reality; the perceived advantage of a test to end users means that many port diagnostics are used in every day practice whilst more accurate tests languish in the wings. Managing the perception of the test is critical and finding the most appropriate test is even more important. A further clinical myth challenged in this step is data from one land mark trial is all that is needed to support perceived value of the test. In actual fact, in addition to compelling clinical data, observability of data and trialability is required to create grass root clinical pull of that test. The next clinical myth that is challenged is that agreeing test standard is just a launch task. In reality lack of clinical agreement on what and how to benchmark a test permit a multiplicity of “gold standards” which are means that the best tests may be masked by others looking better than they are. An opportunity to shape the market exists as a result. Hence it is important to seek standard testing as early as possible.

Step 410 addresses the issue of the clinical market insights. For predictable entry, the following criteria need to be considered. The management of end user perception of the pharmaceutical and the building of grass roots clinical momentum to support this treatment or theranostic is important. Finally if the standard can be influenced in the direction of the technology and the theranostic, this will also be of great assistance at this time in the process as it will open opportunities later on in the plan.

Step 412 investigates the decisions required at the clinical point in the framework. This relates to the market insights mentioned above. In order to manage the end user perception, it is important that doctors realize the advantages over the ideas that currently exist. The doctors also need to see the compatibility of their existing values, past experiences and needs with the present plan. In addition, doctors need to understand the complexity or lack thereof of the process.

The perceived advantages of the adopters may then be used to push the trialability of particular clinical trial. This can be further encouraged by earlier trial approval requests on an adhoc basis; publication of results; protection of results; chemical or biochemical elements of the treatment; education programs for doctors and patients alike; and publication of results prior to launch. The ability to shape the development of the treatment can be improved by ensuring that the standards adopt and use the clinical program. If all these things are taken into consideration, the clinical fit and test options are determined that best match the clinical needs.

The clinical decisions may also be represented by means of questions, these are:
What data do we require to prove the value of the proposition—do we need a perception stakeholder group to help us?
What are our plans for a regional usage trial strategy?
What are our plans for a development clinical communications strategy to mirror the research pre-launch?
How will we shape the diagnostic standards?

Step 414 challenges the myth that regulatory inconsistencies present a risk to diagnostic industry interaction. In reality the drug approval associations, for example the FDA, lead the field in their assessment of molecular diagnostics and targeted therapy. This encourages a sustained partner-like relationship with the research and development paradigms. Another challenged myth is that the fastest route to market for certain assess is normally the best. In reality, whilst “home ground tests” continue to be a valid form of development in pre-launch, they are often used by the diagnostic industry to avoid scrutiny. As a consequence, they may have negative effects on the R&D commercialization in the long term.

A further challenged myth is that it is not necessary to do prospective validation of biomarkers. In reality, it is essential to ensure that the data requirements support the clinical purposes for which the test is required. Prospective data will be a key part in validating the clinical value of the test. A further challenged myth is that the link between an R&D label is a major disadvantage. In reality a research label link to a development is not a disadvantage. The key is managing the test options available therein.

Step 416 deals with the regulatory market insights. In order to achieve predictable entry, it is important to consider the following issues: coordination of dialogue with regulators; planning the regulatory paths past launch; proving the value; and managing the label relationships between research and development.

In step 418, the above-mentioned issues relating to market insights are brought to a decision point. In order to coordinate dialogue, it is important to have the research and development companies communicating directly, potentially through a third party advocate and all three communicating directly with for example the FDA. Important issues to manage are the oversight of partners' regulatory strategy and to determine who, where, what and frequency of guidance meetings and submission meetings and to define this openness legally if appropriate.

The decisions of the regulatory framework can be exemplified by the following questions:
How will we ensure we have oversight over our partners' regulatory strategy?
What is our regulatory path up to and beyond launch?
Do we need any additional clinical data (over Cl) specifically for regulatory purposes?
Have we captured the ideal test and research label interactions for our proposition?

In order to plan the path beyond launch, it is important to have a plan of the timescale for the regulatory stage and how that will impact the evolution of the tests and the final commercial drug or treatment.

In order to prove the value of the offering, it is important to discuss the offering with patients, pharmacists, medical staff who prescribe drugs and treatments, the payers and of course the development and research institutions. In these discussions, it is important to identify the prospective data needs which will prove the value or purpose of the tests.

In order to manage the label, it is important to seek out the ideal test labels for the proposition.

Step 420 deals with the risk myth and reality of the access framework. The myth that clinical utility will ensure the fusion of the test is challenged. In reality the profit chain has a disproportional impact on the attractiveness of most tests and their up take in the market place. In addition, a further myth is that CPT code (correct procedural terminology code is the number given to each diagnostic or tool which a doctor uses in a clinic, for example a tongue depressor has a CPT code which may be used by insurance companies to fix a rate to pay against that specific CPT code) is a launch action. In reality coding decisions for tests are critical and need to be addressed early and can incorporating a payer perspective if possible. The final myth challenged in the access framework is the myth of not needing to worry about reimbursement support, as the diagnostic partner will do that. In reality confusion and original variations abound with new tests and there are associated adoption issues. Only the bigger diagnostic companies devote departments to customer support, but it is an important thing to consider in the access domain.

Step 422 deals with the market insight of the access framework. In order to guarantee a predictable entry the following criteria must be considered: let the market forces work; prove the value to payers; and resource the burden.

At step 424 the decision analyses of these access metrics are considered to ensure that an economic market is developed. In order to let the market forces work it is important to remember that this can take two years or more to obtain and seed a new CPT. In order to prove the value it is important that the responses of the payer should be analyzed and determined. It is important that the value is presented to the payer in such a way that their responses are satisfied. In order to resource the burden it is important to determine the dedicated resources required for a variety of different actions. For example, there may be requirements in respect of counseling, uncertain billing, equivocal results, prior authorization and the like. These need to be dealt with by doctors, laboratory workers, payers and patients. Hence the resource burden may be vast and should be considered as early as possible in the access stage. In order to assess the access fit it is important to determine whether the test answers the questions required. It is further important to change the target test profile if required, but not if not. Finally, it is important to consider how the test needs to perform.

Again the access framework decisions can be represented by the following exemplary questions:
Do we need a new code or can we work with existing codes?
Who will we employ to manage our coding strategy?
What is our payer strategy and who will manage it?
What is our access management strategy for customers and who will manage it?

Step 426 challenges the myth relating to marketing. The first myth is that marketing diagnostics is specialized and best left to the partner. In reality there is little branding and little positioning and no debate about how targeted therapies will be co-promoted tomorrow. The next myth challenge is that it is okay to have marketing spend in line with the industry. In reality embedded behavior, small budgets and a lack of role models achieves the perspective that few diagnostics are worth greater than 5 million of market spending. This is not always the case. The final myth challenged in the marketing section is that the patient does not need to be factored into the thinking or adoption. In reality considering the patients' role in diffusion will help drive adoption in certain types of test. This is particularly the case in personalized medicine.

In step 428, the marketing market insights are identified in order for predictable entry: it is important to align positioning; introduce diagnostic brands; budget realistically; and consider the patient.

This is then fed into the decision analysis at step 430 and used to established brand momentum. In order to align positioning it is important to identify the market, brand names, the proposition, the patient segment and any supporting evident. In addition it is important to present the information in a clear manner. In order to align positioning, it is important to understand at which point between research and development we are located.

Again the marketing framework decisions can be represented by the following exemplary questions:
Have we adequately captured the positioning statement for the test?
What is our branding strategy?
As part of the branding strategy what are the plans for physician and patient education?
What patient research do we need? What plan to drive testing do we need?

In order to introduce branding, there are number of criteria to be taken into considerations. These include pre-launch issues, awareness, loyalty, DTC (refers to direct to consumer advertising) recognition, quality of care, ownership, top of mind (refers to the frequency with which an item is top of a doctors' mind), guidelines, third party endorsement and differentiation. Each of these is considered within the bounds of realistic budgeting. The realistic budgeting requires a knowledge of how much should be budgeted and identifying when expenditure goes beyond budget and identify whether this is appropriate or not.

In considering the patient it is important to demonstrate to the patient that the test offers more advantages than it takes. In addition the patients' needs need to be considered in determining whether there is a need or opportunity to consider development DTC in the plans.

Step 432 deals with the myth and realities of selling. The major myth challenge here is that the test is a great way to manage the disease and it will thus sell its self. In reality, novel test require direct selling and persistence. The cost of this puts development companies off at least initially. Later they may realize they have no choice and then be late to market.

Step 434 looks at the market insight of selling. In order for predictable entry the following considerations should to be made align development, get the detail right, and measure adoption.

Step 436 looks at the decision analysis of selling that result from those market insights and examines how to sell the test. In order to align development it is important to identify where the sales reps, sales force and distributors may be found. Their locations, their roles, their capabilities and their coordination need to be considered. It is important that all of these people contact the relevant bodies. For example all need to visit the doctors' offices. In addition there is a need to be communication of the direct sales force and the national distributors with the laboratories and in turn the laboratories need to continue to communicate with doctors.

Again the selling framework decisions can be represented by the following exemplary questions:
What is the profile, reach and frequency of the direct sales representative we require and who will provide this for us?
What is the clear control and command structure in place across our sales groups?
Have we identified who will design, approve and evolve the launch technical information required?
What is our plan to measure adoption in the clinics?

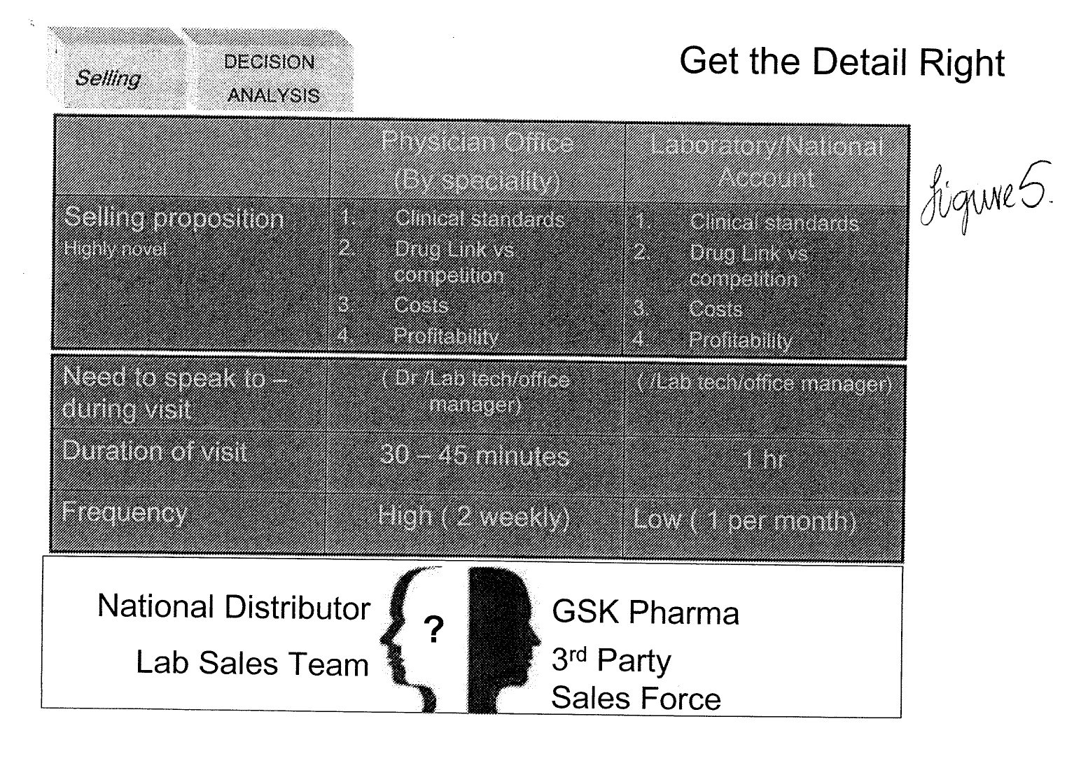

Referring now to FIG. 5, a table is shown identifying how to get the details of the selling relationship right. The table deals with the different elements of the selling proposition and how they should be specifically communicated to doctors' offices and laboratories alike. These selling propositions include clinical standards, drug link versus competition, cost and profitability. The details will also require identification of key personnel, duration and frequency of visit. Different considerations may be required for links with ones own laboratory, contracted laboratories or specialized laboratories and the doctors' offices. This may influence the design and functionality of order forms billing, profitability interpretations and guidelines. In order to measure adoption, it is important to determine the development to research ratio. On the development side there is the drug and IMS, (which provides market share and prescription data on each therapy quarterly.). On the research side there are the test, the development, sales, survey information, panels (market research focus groups with doctors) and ICD9. (The name given to codes a US doctor ascribes to a particular diagnosis, e.g. a sore throat will have its own ICD9 code.) By considering all these elements it is possible to determine the ratio of development to research and measure the adoption.

Step 438 deals with the myth and reality of the life cycle. The challenged myth is that it is important at the moment to focus only on launch planning. In reality, an understanding of how the market and technology are to evolve and to be protected will help with both current decision and future planning.

The market insights of the life cycle element at step 440 require that for predictable entry the evolution of the market and the protection of franchise are carefully managed. This brings about an advance life cycle for the test etc . . .

At step 442 the decision analyses of this evolution and protection of franchise are considered. In order to evolve the market it is important to continue laboratory diagnostics and monitor carefully the drug effect. Should new indication come to light this must be dealt with quickly and efficiently. In order to protect the franchise it is important to understand third party segmenting tests and how they impact the laboratory diagnostic drug effect monitoring and any new indications.

Again the life cycle framework decisions can be represented by the following exemplary questions:
What is our strategy to protect/evolve the test franchise after launch?
What is our contingency plan against market events & competitor test segmenting our market?
What are the IP issues across all of our theranostic plan?

The final frame work considered is the partner framework. Step 444 deals with the myth and reality of partners. A common myth is that the partner used today must have the technology wanted. In reality, successful partnership thrive on the pharmaceutical knowing what is wanted from the outset and building a relationship around it which gives a win-win deal for both parties. A further myth is that too close a link to a test partner can backfire. In reality, there are great risks to the brand by not assuming full ownership of any relationship with partners. The final myth challenge in this step is the myth that by setting up a diagnostic partnership it can be left to run on its own. In reality history has shown that research and development relationships are high maintenance and require ongoing nurturing throughout the whole life cycle.

The marketing insights of the partner framework show that to ensure predictable entry the following considerations need to be taken. The first is “know your needs”, the second is defining rules of engagement and the third is nurturing the relationship throughout the relationship.

The decision analysis step 448 of the partner framework leads to building a true partnership. In order to address the issue of knowing your needs it is important to ask the question whether the technology partner can provide all the needs. This requires checking things such as technical development; life cycle; ability to sell the test; creating brand pull; creating an economic market aligning with regulatory strategies; creating a clinical pull etc . . . It is important to determine whether the partner can help with all these aspects.

Again the partner framework decisions can be represented by the following exemplary questions:
How do we plan to manage the alliance of multiple partners?
What type of relationship do we want with our partners? Do we need to brief business development on the level of control we require?
What is our partner incentive plan to ensure a focus on our multiple adoption milestones?
How will we nurture the relationship/s financially?
What is the structure in place to ensure efficient communication across the multiple partnerships required to cope with changes/evolution of our needs?

In terms of defining the rules of engagement between the partners it is important to have a win-win situation that is possibly managed under a legal framework. In order to define a rule of engagement between the partners it is important to understand whether this is co-development with co-investment by both parties and whether it is a development fee for service type partnership, where cost sharing is not on an equal basis. Understanding the ownership and partner type is important. The need for control is also considered in order to define the role of engagement between the parties. The development mile stones; marketing goals; speed of clinical adoption and percentages of clinical adoption are also other factors that need to be agreed by the partner. In order to nurture the relationship between the two partners it is important to understand that relationships financially aspects and to never stop communicating. Without these aspects there may be no success in the partnership.

By following the framework and steps alighted above a blue print for theranostic success can be achieved.

The resulting theranostic plan that is derived from this business method is optimal in today's market place. The myth and realities of the pharmaceutical and diagnostic market places are cohesively linked and key actions and decisions are clearly identified. How one comes to this set of steps has been a non trivial journey and is still developing.

The theranostic plan capture stages are then augmented with data from a predictive model to create a theranostic plan which is the final written capture document for all decisions and modeling. The theranostic plan may also contain a specific appendix which translates the pharmaceutics company theranostic plan into a partner selection tool.

It would be appreciated that the essential framework of this theranostic plan and method gives a number of key advantages over prior art systems and current methodologies. In addition, the ability of pharmaceutical diagnostic market to work together has been achieved.

It would obvious that the above described invention may be varying in many ways. Such variations are not to be regarded as a departure from this portion scope of the invention and as such all such modifications are intended to be included within the scope of the invention.

TABLE 1

| Framework | Objective | Key Actions | Decisions |
|---|---|---|---|
| Strategic | Think Diffusion | Define Adoption Goals | 2 |
| | | Consider Technology Fit | |
| Clinical | Create clinical | Manage end user perception | 4 |
| | Pull | Build grass roots clinical | |
| | | momentum | |
| | | Shape the standards | |
| Regulatory | Drive Regulatory | Coordinate dialogue with | 4 |
| | Strategy | regulators | |
| | | Plan the regulatory path | |
| | | past launch | |
| | | Prove the value | |
| | | Manage the label | |
| | | relationship | |
| Access | Make an | Let market forces work | 4 |
| | Economic Market | Prove the value to payers | |
| | | Resource the burden | |
| Marketing | Establish Brand | Align positioning | 5 |
| | Momentum | Introduce diagnostic brands | |
| | | Budget realistically | |
| | | Consider the patient | |
| Selling | Sell the Test | Align deployment | 4 |
| | | Get the detail right | |
| | | Measure adoption | |
| Lifecycle | Consider the | Evolve the market | 3 |
| | Lifecycle | Protect the Franchise | |
| Partners | Build true | Know your needs | 4 |
| | Partnerships | Define rules of engagement | |
| | | Nurture the relationship | |

1. A method of determining a theranostic plan for a pharmaceutical, the plan being optimized in terms of return on investment (ROI), the method comprising:
determining a plurality of planning frameworks which take the pharmaceutical from a point of conception to a point of marketing and beyond;
for the or each framework determining a plurality of planning steps which lead to the definition of a plurality of required decisions;
effecting a plurality of decisions corresponding to the required decisions;
carrying out the plurality of decisions in a predetermined order, based on the framework and planning steps, so as to put the theranostic plan into effect, wherein the carrying out the decisions is made so as to optimize the ROI of the theranostic plan.

2. The method of claim 1, wherein the step of determining a plurality of planning frameworks comprises determining one or more of the following frameworks:
a strategic framework
a clinical framework
a regulatory framework
an access framework
a marketing framework
a selling framework
a lifecycle framework; and
a partner framework.

3. The method of claim 1, wherein the step of determining a plurality of planning frameworks comprises determining a combination of the following frameworks:
a strategic framework
a clinical framework
a regulatory framework
an access framework
a marketing framework
a selling framework
a lifecycle framework; and
a partner framework.

4. The method of claim 1, wherein the step of determining a plurality of planning frameworks comprises determining all of the following frameworks:
a strategic framework
a clinical framework
a regulatory framework
an access framework
a marketing framework
a selling framework
a lifecycle framework; and
a partner framework.

5. The method of claim 1, wherein determining a plurality of planning steps which lead to the definition of a plurality of required decisions comprising determining one or more of the following steps:
identifying one or more myths associated with a framework;
identifying one or more realities associated with a framework;
identifying one or more objectives associated with a framework;
identifying one or more required decisions associated with a framework.

6. The method of claim 1, wherein determining a plurality of planning steps which lead to the definition of a plurality of required decisions comprising determining a combination of the following steps:
identifying one or more myths associated with a framework;
identifying one or more realities associated with a framework;
identifying one or more objectives associated with a framework;
identifying one or more required decisions associated with a framework.

7. The method of claim 1, wherein determining a plurality of planning steps which lead to the definition of a plurality of required decisions comprising determining all of the following steps:
identifying one or more myths associated with a framework;
identifying one or more realities associated with a framework;
identifying one or more objectives associated with a framework;
identifying one or more required decisions associated with a framework.

8. The method of claim 2, wherein determining a plurality of planning steps which lead to the definition of a plurality of required decisions comprising determining one or more of the following steps:
identifying one or more myths associated with a framework;
identifying one or more realities associated with a framework;
identifying one or more objectives associated with a framework;
identifying one or more required decisions associated with a framework.

9. The method of claim 3, wherein determining a plurality of planning steps which lead to the definition of a plurality of required decisions comprising determining one or more of the following steps:
identifying one or more myths associated with a framework;
identifying one or more realities associated with a framework;
identifying one or more objectives associated with a framework;
identifying one or more required decisions associated with a framework.

10. The method of claim 4, wherein determining a plurality of planning steps which lead to the definition of a plurality of required decisions comprising determining one or more of the following steps:
identifying one or more myths associated with a framework;
identifying one or more realities associated with a framework;
identifying one or more objectives associated with a framework;
identifying one or more required decisions associated with a framework.

11. The method of claim 1, further comprising carrying out the decisions by determining the answers to one or more key questions for the or each framework.

12. The method of claim 1, further comprising translating the theranostic plan into a partner selection tool.

13. The method of claim 1, further comprising assessing the perception of the complexity of a new test by measuring one of more of the following attributes associated with the test:
reimbursement levels;
turnaround time for the test;
interpretations of results;
patient engagement; and
test administration.

14. A system for determining a theranostic plan for a pharmaceutical, the plan being optimized in terms of return on investment (ROI), the system comprising:
a plurality of planning frameworks which take the pharmaceutical from a point of conception to a point of marketing and beyond;
for the or each framework a plurality of planning steps which lead to the definition of a plurality of decisions;
wherein the plurality of decisions are carried out in a predetermined order, based on the framework and planning steps, so as to put the theranostic plan into effect, and wherein the carrying out the decisions is made so as to optimize the ROI of the theranostic plan.

15. A computer program comprising instructions for carrying out the steps of determining a theranostic plan for a pharmaceutical, the plan being optimized in terms of return on investment (ROI), comprising:
determining a plurality of planning frameworks which take the pharmaceutical from a point of conception to a point of marketing and beyond;
for the or each framework determining a plurality of planning steps which lead to the definition of a plurality of required decisions;
effecting a plurality of decisions corresponding to the required decisions;
carrying out the plurality of decisions in a predetermined order, based on the framework and planning steps, so as to put the theranostic plan into effect, wherein the carrying out the decisions is made so as to optimize the ROI of the theranostic plan,
the steps being effected when said computer program is executed on a computer system.
